(19) United States
(12) Patent Application Publication
(10) Pub. No.: US 2020/0255577 A1
(43) Pub. Date: Aug. 13, 2020

(54) PROCESS FOR PREPARING POLYURETHNE FOAMS

(71) Applicant: RHODIA OPERATIONS, Paris (FR)

(72) Inventors: Shujing CHENG, Shanghai (CN); Weijie ZHOU, Shanghai (CN); Zhaoming ZHENG, Shanghai (CN); Julien Rabih CHET, Shanghai (CN)

(21) Appl. No.: 16/489,559

(22) PCT Filed: Dec. 2, 2016
(86) PCT No.: PCT/CN2016/108336

§ 371 Date: Aug. 28, 2019

(51) Int. Cl. C08G 18/18; C08J 9/14; C08G 18/42; C08G 18/40; C08G 18/48; C08G 18/76

(52) U.S. Cl. CPC C08G 18/1833; C08J 9/144; C08G 18/42; C08G 2101/0025; C08G 18/4833; C08G 18/4804; C08G 18/7664; C08G 18/4018

(57) ABSTRACT

The present invention relates to a process for preparing a polyurethane foam by reacting a polyisocyanate with a polyol in the presence of a blow agent and a particular family of amine. The present invention also relates to a polyurethane foam thereof.

### TECHNICAL FIELD

The present invention relates to an amine for use as catalyst in the process of preparing a polyurethane foam. The amine of the present invention can be used for preparing flexible, semi-rigid or rigid polyurethane foams, notably, rigid foams.

### BACKGROUND ART

Polyurethane foams are widely used as flexible foams e.g. for automobile seat cushions, mattresses and furniture; as semi-rigid foams e.g. for automobile instrument panels, head rests and arm rests; and as rigid foams e.g. for refrigerators and building materials.

The polyurethane foam is formed mainly through two reactions including a reaction of a polyol with a polyisocyanate (gelling reaction) to form a urethane linkage, and a reaction of an isocyanate with water (blowing reaction) to form a urea linkage and to evolve carbon dioxide. It is highly desirable that a catalyst is employed during the process of preparing polyurethane foams. The catalyst affects not only the reaction rates but also the curing rate, the moldability, the flowability of the foam, foam density and the properties of the foam. Catalyst for preparing polyurethane foams may be classified as either blowing catalysts or gelling catalysts, depending on their relative catalytic activity respecting either generation of CO₂ via the water/isocyanate interaction or the gelling reaction via the OH/isocyanate interaction. Blowing catalysts and gelling catalysts are classified by those skilled in the art as either weak or strong, depending on the relative vigor with which they catalyse the blowing or gelling reaction. There are also so-called balanced catalysts, which have substantially similar level of catalytic activities in the blowing and the gelling reactions.

Amines, notably tertiary amines, are widely known to be excellent catalysts for production of polyurethane. The amines employed industrially for polyurethane production include triethylenediamine, N,N,N′,N″,N″-pentamethyldiethylene-triamine, N,N,N′,N′-tetramethylhexamethylenediamine, N-methyl-N′-(2-dimethylaminoethyl)piperazine, triethylamine, N-methylmorpholine, N-ethylmorpholine, and dimethylcyclohexylamine.

The amines which are known for use as polyurethane production catalysts have various disadvantages. For example, tertiary amines emit offensive strong odor. In particular, amines of relatively low molecular weight, such as dimethylcyclohexylamine, emit extremely pungent odor, and worsen the working environment greatly by the strong odor in the foaming process. Furthermore, the resulting polyurethane product has also residual offensive odor, or emits the amine to impair the value of the product, disadvantageously.

U.S. Pat. No. 5,605,939 discloses bis(2,2′-dimethylamino)ethyl ether for use as catalyst for preparing polyurethane foams. Bis(2,2′-dimethylamino)ethyl ether is known to be a strong blowing catalyst, which would lead to fast blowing reaction. One drawback is that it would cause difficulties in controlling the foaming behaviours of the polyurethane therewith. This is particularly unfavourable for certain applications, such as molding, in which moderate cure rate is preferred so that the polyurethane foams can distribute sufficiently and evenly within the mold before the foams gel.

One objective of the present invention is to provide a process for producing a polyurethane foam by using an amine as catalyst which has less odor and lower volatility. Another objective of the present invention is to provide a process for producing a polyurethane foam by using an amine as catalyst which gives moderate cure rate and balanced promotion of gelling and blowing reactions, Still another objective of the present invention is to provide a process for producing a polyurethane foam by using an amine as catalyst which has good stability characteristics. Still another objective is to provide a polyurethane foam which has excellent physical properties by employing an amine for use as catalyst in the preparation of the polyurethane foam.

### SUMMARY OF INVENTION

The present invention relates to a process for preparing a polyurethane foam by reacting a polyisocyanate with a polyol in the presence of a blow agent and an amine, wherein the amine has the general formula of:

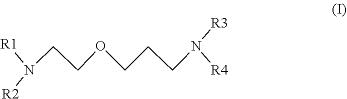

wherein R₁, R₂, R₃, R₄ are, independently, linear or branched C₁ to C₄ alkyl, H, or —OH. Advantageously, at least one of R₁ and R₂ is methyl and at least one of R₃ and R₄ is methyl. More advantageously, R₁, R₂, R₃, R₄ are independently methyl, H, or —OH.

The amine of the present invention acts as catalyst for the polyurethane polymerization reactions. In particular, the amine can execute balanced promotion of blowing reaction and gelling reaction. It has been surprisingly found that the amine can provide moderate cure rate and it allows the polyurethane foams therewith to have desired foaming behaviours.

When being used for the process of the present invention, the amine may be used singly or in combination with a co-catalyst. The co-catalyst includes and is not limited to other tertiary amines, tertiary amine compounds having an active hydrogen reactive to the isocyanate, organometal compounds, and/or metal carboxylates for polyurethane production.

The process of the present invention may be used for preparing flexible, semi-rigid or rigid polyurethane foams, in particular, rigid polyurethane foams.

The present invention also relates to a polyurethane foam comprising the reaction product of: a polyisocyanate, a polyol, a blow agent and an amine, wherein the amine has the general formula of:

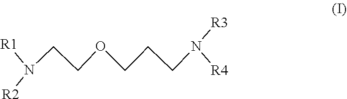

wherein R₁, R₂, R₃, R₄ are, independently, linear or branched C₁ to C₄ alkyl, H, or —OH.

The present invention further relates to a polyurethane foam comprising an amine having the general formula of:

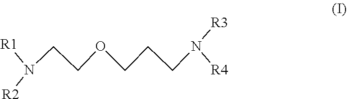

wherein R₁, R₂, R₃, R₄ are, independently, linear or branched C₁ to C₄ alkyl, H, or —OH.

### DETAILED DESCRIPTION

Throughout the description, including the claims, the term “comprising one” or “comprising a” should be understood as being synonymous with the term “comprising at least one”, unless otherwise specified, and “between” should be understood as being inclusive of the limits.

It should be noted that in specifying any range of concentration, weight ratio or amount, any particular upper concentration, weight ratio or amount can be associated with any particular lower concentration, weight ratio or amount, respectively.

As used herein, the term “alkyl” means a saturated hydrocarbon radical, which may be straight, branched or cyclic, such as methyl, ethyl, n-propyl, iso-propyl, n-butyl, sec-butyl, t-butyl, pentyl, n-hexyl, cyclohexyl.

As used herein, the terminology “Cm-Cn” in reference to an organic group, wherein m and n are each integers, indicates that the group may contain from m carbon atoms to n carbon atoms per group.

In one aspect, the present invention relates to a process for preparing a polyurethane foam by reacting a polyisocyanate with a polyol in the presence of a blow agent and an amine, wherein the amine has the general formula of:

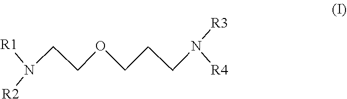

wherein R₁, R₂, R₃, R₄ are, independently, linear or branched C₁ to C₄ alkyl, H, or —OH.

Advantageously, the amine has the general formula of:

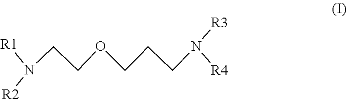

wherein R₁, R₂, R₃, R₄ are, independently, linear or branched C₁ to C₄ alkyl, H, or —OH; at least one of R₁ and R₂ is methyl and at least one of R₃ and R₄ is methyl.

More advantageously, the amine has the general formula of:

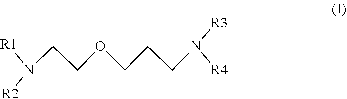

wherein R₁, R₂, R₃, R₄ are independently methyl, H, or —OH.

Examples of the amine according to the present invention include and are not limited to: 2-(3-(hydroxy(methyl)amino)propoxy)-N,N-dimethylethan-1-amine; 3-(2-(dimethylamino)ethoxy)-N-methylpropan-1-amine; 3-(2-(dimethylamino)ethoxy)-N-ethyl-N-methylpropan-1-amine; 3-(2-(hydroxy(methyl)amino)ethoxy)-N,N-dimethylpropan-1-amine; N,N-dimethyl-3-(2-(methylamino)ethoxy)propan-1-amine; 3-(2-(ethyl(methyl)amino)ethoxy)-N,N-dimethylpropan-1-amine.

In an exemplary embodiment of the present invention, the amine is 3-[2-(dimethylamino)ethoxy]-N,N-dimethylpropylamine, 2-(3-(hydroxy(methyl)amino)propoxy)-N,N-dimethylethan-1-amine, 3-(2-(dimethylamino)ethoxy)-N-methylpropan-1-amine or a mixture thereof.

The amine of the present invention, which has a lower vapor pressure than conventional amine catalysts, emits less odor, thereby improving working environment for polyurethane production significantly, and giving low residual odor and reducing the volatile matter in the produced polyurethane foam.

When being used for the process of the present invention, the amine may be combined with a co-catalyst including other tertiary amines, tertiary amine compounds having an active hydrogen reactive to the isocyanate, organometal compounds, and/or metal carboxylates for polyurethane production.

Suitable co-catalyst, include, for example, tertiary amines such as triethylamine, N,N-dimethylcyclohexylamine, N,N,N′,N′-tetramethylethylenediamine, N,N,N′,N′-tetramethylpropylenediamine, N,N,N′,N″,N″-pentamethyl-(3-aminopropyl)ethylenediamine, N,N,N′,N″,N″-pentamethyldipropylenetriamine, N,N,N′,N′-tetramethylguanidine, 1,3,5-tris(N,N-dimethylaminopropyl)hexahydro-s-triazine, N,N,N′,N′-tetramethylhexamethylenediamine, N-methyl-N′-(2-dimethylaminoethyl)piperazine, N,N′-dimethylpiperazine, N-methylpiperazine, N-methylmorpholine and N-ethylmorpholine. The above mentioned tertiary amine compounds having an active hydrogen include alkanolamines such as N,N-dimethylaminoethanol, N,N-dimethylaminoisopropanol, N,N-dimethylaminoethoxyethanol, N,N,N′trimethylaminoethylethanolamine, N,N,N′-trimethyl-N′-hydroxyethyl-bisaminoethyl ether, N,N-bis(3-dimethylaminopropyl)-N-isopropanolamine, N-(3-dimethylaminopropyl)-N,N-diisopropanolamine, N-(2-hydroxyethyl)-N′-methylpiperazine, and N,N-dimethylaminohexanol; and amine compounds having both a primary amino group and a secondary amino group such as dimethylaminopropylamine, and bis(dimethylaminopropyl)amine. Such amine compounds having active hydrogen react with the isocyanate to be incorporated into the foam, thereby reducing volatilization of amine.

The amine may also be combined with an organometal compound and/or a metal carboxylate as the co-catalyst. The organometal compound includes, for example, stannous diacetate, stannous dioctoate, stannous dioleate, stannous dilaurate, dibutyltin oxide, dibutyltin diacetate, dibutyltin dilaurate, dibutyltin dichloride, dioctyltin dilaurate, lead octanoate, lead naphthenate, nickel naphthenate, and cobalt naphthenate. Of these organometal compounds, organotin compounds are preferred. The metal carboxylate includes, for example, alkali metal salts or alkaline earth metal salts of carboxylic acids. The carboxylic acid includes, for example, aliphatic mono- and di-carboxylic acids such as acetic acid, propionic acid, 2-ethylhexanoic acid, and adipic acid; aromatic mono- and di-carboxylic acids such as benzoic acid, and phthalic acid. The salt-forming alkali metal includes, for example, lithium, sodium, and potassium; and the salt-forming alkaline earth metal includes calcium, and magnesium.

The usual amount of the amine in polyurethane production is generally in the range of from 0.01 to 10 parts by weight based on 100 parts by weight of the polyol, preferably in the range of from 0.2 to 8 parts by weight based on 100 parts by weight of the polyol, more preferably in the range of from 0.5 to 5 parts by weight based on 100 parts by weight of the polyol. The amount of the aforementioned co-catalyst to be used in combination with the amine catalyst of the present invention is generally in the range of from 0.01 to 5 parts by weight.

The amine may be used singly or in combination with a co-catalyst as described above. In mixing of the catalyst components, a solvent such as dipropylene glycol, ethylene glycol, 1,4-butanediol and water may be used, if necessary. The solvent is used in an amount preferably of not more than 70% by weight of the entire catalyst components, but the amount is not limited thereto. The catalyst thus prepared may be added to the polyol. Otherwise, respective amine catalyst component may be separately added to the polyol. The method of the catalyst addition is not specially limited.

Polyol

The polyol used in the process of the present invention may be a polyol or a polyol composition comprising at least one component having an average hydroxyl equivalent weight of from about 800 to about 3000, preferably from about 800 to about 2000, and more preferably from about 800 to about 1500. Advantageously, such polyol has a molar average of from about 2 to about 8, preferably from about 3 to about 6 active hydrogen atoms per molecule.

Suitable polyols include polyester polyols and polyether polyols.

Exemplary of suitable polyether polyols are those prepared by polymerizing an alkylene oxide such as, for example, ethylene oxide, 1,2-propylene oxide, 1,2- or 2,3-butylene oxide or mixtures thereof, with an initiator containing from 2 to 8, preferably from about 3 to about 6 active hydrogen atoms per molecule in the presence of an alkoxylation catalyst. Examples of initiators suitable for the present invention include water, alkylene glycols such as ethylene glycol and propylene glycol, glycerine, trimethyolpropane, pentaerythritol, sorbitol, sucrose, bis 2,2-(4-hydroxyphenyl) propane, aniline, ethanolamine, ethylenediamine, N(1-aminoethyl)piperazine, alkoxylated adducts thereof, and mixtures thereof.

Polyisocyanate

The polyisocyanate suitable for the present invention may be aliphatic, cycloaliphatic, araliphatic, preferably aromatic polyfunctional isocyanates.

In particular, examples of polyisocyanates suitable for the present invention include and are not limited to: alkylene diisocyanates having from 4 to 12 carbon atoms in the alkylene radical, for example dodecane 1,12-diisocyanate, 2-ethyltetramethylene 1,4-diisocyanate, 2-methylpentamethylene 1,5-diisocyanate, tetramethylene 1,4-diisocyanate and preferably hexamethylene 1,6-diisocyanate; cycloaliphatic diisocyanates such as cyclohexane 1,3- and 1,4-diisocyanate and also any mixtures of these isomers, 1-isocyanato-3,3,5-trimethyl-5-isocyanato-methylcyclohexane (IPDI), hexahydrotolylene 2,4- and 2,6-diisocyanate and also the corresponding isomer mixtures, dicyclohexylmethane 4,4′-, 2,2′- and 2,4′-diisocyanate and also the corresponding isomer mixtures, and preferably aromatic polyisocyanates such as diphenylmethane 4,4′-, 2,4′- and 2,2′-diisocyanate and the corresponding isomer mixtures, mixtures of diphenylmethane 4,4′- and 2,2,1′-diisocyanates, poly-phenylpolymethylene polyisocyanates, mixtures of diphenylmethane 2,4′-, 2,4′- and 2,2′-diisocyanates and polyphenylpolymethylene polyisocyanates (raw MDI).

The polyisocyanate may also be modified polyfunctional isocyanates, i.e. products which are obtained by chemical reaction of organic diisocyanates and/or polyisocyanates. Examples which may be mentioned are diisocyanates and/or polyisocyanates containing ester, urea, biuret, allophanate, carbodiimide, isocyanurate, uretdione and/or urethane groups. Specific examples of modified isocyanates are: organic, preferably aromatic polyisocyanates containing urethane groups and having NCO contents of from 33.6 to 15% by weight, preferably from 31 to 21% by weight, based on the total weight, for example diphenylmethane 4,4′-diisocyanate modified with low molecular weight diols, triols, dialkylene glycols, trialkylene glycols, or polyoxyalkylene glycols having molecular weights of up to 6000, in particular molecular weights of up to 1500, modified raw MDI or tolylene 2,4- or 2,6-diisocyanate, with examples of dialkylene or polyalkylene glycols, which can be used individually or as mixtures, being: diethylene glycol, dipropylene glycol, polyoxyethylene, polyoxypropylene and polyoxypropylene-polyoxyethene glycols, triols and/or tetrols. Also suitable are prepolymers containing NCO groups, having NCO contents of from 25 to 3.5% by weight, preferably from 21 to 14% by weight, based on the total weight, and prepared from the polyester polyols and/or preferably polyether polyols described below and diphenylmethane 4,4′-diisocyanate, mixtures of diphenylmethane 2,4′- and 4,4′-diisocyanate, tolylene 2,4- and/or 2,6-diisocyanates or raw MDI. Other modified isocyanates which have been found to be useful are liquid polyisocyanates containing carbodiimide groups and/or isocyanurate rings and having NCO contents of from 33.6 to 15% by weight, preferably from 31 to 21% by weight, based on the total weight, for example those based on diphenylmethane 4,4′-, 2,4′- and/or 2,2′-diisocyanate and/or tolylene 2,4- and/or 2,6-diisocyanate.

If desired, the modified polyisocyanates can be mixed with one another or with unmodified organic polyisocyanates such as diphenylmethane 2,4′- and/or 4,4′-diisocyanate, raw MDI, tolylene 2,4- and/or 2,6-diisocyanate.

Polyisocyanates suitable for the present invention may also be mixtures of tolylene diisocyanates and raw MDI or mixtures of modified organic polyisocyanates containing urethane groups and having an NCO content of from 33.6 to 15% by weight, in particular those based on tolylene diisocyanates, diphenylmethane 4,4′-diisocyanate, diphenylmethane diisocyanate isomer mixtures or raw MDI and in particular raw MDI having a diphenylmethane diisocyanate isomer content of from to 80% by weight, preferably from 30 to 60% by weight, in particular from 30 to 55% by weight.

Blowing Agent

Blowing agents suitable for the present invention include, for example, water which reacts with isocyanate groups to form carbon dioxide, and/or physically acting blowing agents. Suitable physically acting blowing agents are liquids which are inert toward the organic, modified or unmodified polyisocyanates and have boiling points below 100° C., preferably below 50° C., in particular from −50° C. to 30° C., at atmospheric pressure, so that they vaporize under the action of the exothermic polyaddition reaction. Examples of such preferred liquids are alkanes, such as heptane, hexane, n- and iso-pentane, preferably industrial mixtures of n- and iso-pentanes, n- and iso-butane and propane, cycloalkanes such as cyclopentane and/or cyclohexane, ethers, such as furan, dimethyl ether and diethyl ether, ketones such as acetone and methyl ethyl ketone, alkyl carboxylates such as methyl formate, dimethyl oxalate and ethyl acetate and halogenated hydrocarbons such as methylene chloride, dichloromonofluoromethane, difluoro-methane, trifluoromethane, difluoroethane, tetrafluoro-methane, chlorodifluoroethanes, 1,1-dichloro-2,2,2-trifluoro-ethane, 2,2-dichloro-2-fluoroethane and heptafluoropropane. It is also possible to use mixtures of these low-boiling liquids with one another and/or with other substituted or unsubstituted hydrocarbons. Also suitable are organic carboxylic acids such as formic acid, acetic acid, oxalic acid, ricinoleic acid and carboxyl-containing compounds.

Preference is given to using water, chlorodifluoromethane, chlorodifluoroethanes dichlorofluoroethanes, pentane mixtures, cyclohexane and mixtures of at least two of these blowing agents, e.g. mixtures of water and cyclohexane, mixtures of chlorodifluoromethane and 1-chloro-2,2-difluoroethane and, if desired, water.

These blowing agents are usually added to the polyol component. However, they can be added to the isocyanate component or, as a combination, both to the polyol component and to the isocyanate component or premix of these components with other formative components.

The amount of the blowing agent used may be from 1 to 25% by weight, preferably from 5 to 20% by weight, in each case based on the polyol component.

If water is used as the blowing agent, it is preferably added to the polyol component in an amount of from 0.5 to 2% by weight, based on the polyol component. The addition of water can also be carried out in combination with the use of the other blowing agents described.

Optional Ingredients

According to any one of the invention embodiments, the reaction mixture comprising the polyisocyanate and the polyol may further contain other components and additives. Representative of such additives include surfactants, fire-retardant agents, fillers, dyes, pigments, anti-oxidizing agents, fungicides and the like.

Cross-linking agents used to modify foam properties can also be incorporated on the reaction mixture. The cross-linking agent includes low-molecular polyhydric alcohols such as ethylene glycol, diethylene glycol, 1,4-butanediol, and glycerin; low-molecular amine polyol such as diethanolamine, and triethanolamine; polyamines such as ethylene diamine, xylylenediamine, and methylene-bis(o-chloroaniline).

Exemplary of surfactants, which may be present to stabilize or control cell size, are alkoxysilanes, polysilylphophonates, polydimethylsiloxanes, the condensates of ethylene oxide with a hydrophobic base formed by condensing propylene oxide with propylene glycol, the alkylene oxide adducts of ethylenediamine, and the polyoxyalkylene esters of long chain fatty acids and sorbitan, and siloxaneoxyalkylene block copolymers. Preferred such materials are alkoxysilanes, polysilylphophonates, polydimethylsiloxanes, siloxaneoxyalkylene block copolymers.

Examples of suitable surfactants are the “Tegostab” products such as Tegostab B-4113, B-4380, and B-8681 sold by Evonik, DC-5043 sold by Dow Corning Corporation, L6100 and L6900 sold by Momentive. Suitable surfactants also include Tegostab BF-2270, BF-2370, BF-4900 and B-3136 sold by Evonik and the Dow Corning Corporation products DC-190 and DC-198. Generally, such additives are employed in amounts of advantageously from about 0.05 to about 5.0 and preferably of from about 0.1 to about 2.0, parts by weight per one hundred parts of total weight of all polyol present.

The general process for the preparation of polyurethane foams can be conducted by using manners and equipment known to a skilled person. These are discussed, for example, in U.S. Pat. Pub. No. US2002/0086913 A1, U.S. Pat. No. 5,070,112 and G.B. Pat. No. 1,534,258.

The process of the present invention may be used for preparing flexible, semi-rigid or rigid polyurethane foams, in particular for rigid polyurethane foams.

Flexible polyurethane foams have generally an open cell structure exhibiting high air-permeability (airflow) and reversible deformability. The physical properties of a flexible polyurethane foam depend on the chemical structure of the starting polyol and isocyanate, amount of the blowing agent, the chemical factors such as the isocyanate index and the intended cell structure. Generally, the flexible polyurethane foam has a density ranging from 10 to 100 kg/m³, a compression strength (IDL 25%) ranging from 2 to 80 kgf (20 to 800 N), and an elongation ranging from 80 to 500%, but the properties are not limited thereto.

The flexible polyurethane foam includes semi-rigid polyurethane foam in view of the starting materials and foam properties. Semi-rigid polyurethane foams usually have an open cell structure similar to flexible polyurethane foams exhibiting high air-permeability and reversible deformability although the foam density and compression strength are higher than those of the flexible polyurethane foam. The starting polyol and isocyanate are similar to the flexible polyurethane foam. Therefore, the semi-rigid polyurethane foams are generally included in flexible polyurethane foams. The semi-rigid polyurethane foam has generally a density ranging from 40 to 800 kg/m³, 25%-compression strength ranging from 0.1 to 2 kgf/cm² (9.8 to 200 kPa), and an elongation ranging from 40 to 200%. The properties, however, are not limited thereto.

The rigid polyurethane foam generally has a highly crosslinked closed cell structure and is not capable of reversible deformation, and has properties quite different from the properties of flexible foams, and semi-rigid foams. The rigid foam has generally a density ranging from 20 to 100 kg/m³, and a compression strength ranging from 0.5 to 10 kgf/cm² (50 to 1000 kPa), but the properties are not limited thereto.

In one aspect of the present invention, there is provided a polyurethane foam, in particular a rigid polyurethane foam, comprising the reaction product of: a polyisocyanate, a polyol, a blow agent and an amine, wherein the amine has the general formula of:

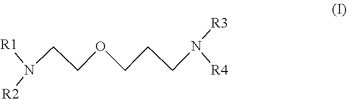

wherein R₁, R₂, R₃, R₄ are, independently, linear or branched C₁ to C₄ alkyl, H, or —OH. Advantageously, at least one of R₁ and R₂ is methyl and at least one of R₃ and R₄ is methyl. More advantageously, R₁, R₂, R₃, R₄ are independently methyl, H, or —OH.

In another aspect of the present invention, there is provided a polyurethane foam comprising an amine having the general formula of:

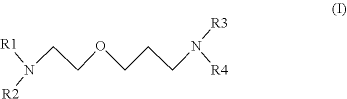

wherein R₁, R₂, R₃, R₄ are, independently, linear or branched C₁ to C₄ alkyl, H, or —OH. Advantageously, at least one of R₁ and R₂ is methyl and at least one of R₃ and R₄ is methyl. More advantageously, R₁, R₂, R₃, R₄ are independently methyl, H, or —OH.

The present invention further provides an article made with the polyurethane foam described herein. The article may be, for example, cushions, mattresses, furniture, automobile instrument panels, head rests and arm rests, insulation materials for refrigerators, building materials.

### EXAMPLES

Polyurethane foams were prepared by using the formulation in Tables 1 and 2 below:

TABLE 1

| | | |
|---|---|---|
| | | Comparative |
| Components | Example 1 | Example 1 |

Component A (100 parts)

| | | |
|---|---|---|
| Polyol 1^{a} | 30.00 | 30.00 |
| Polyol 2^{b} | 34.10 | 34.10 |
| Polyol 3^{c} | 9.50 | 9.50 |
| Flame retardant^{d} | 20.00 | 20.00 |
| Silicone oil 1^{e} | 1.00 | 1.00 |
| Silicone oil 2^{f} | 0.70 | 0.70 |
| 3-[2-(dimethylamino)ethoxy]- | 0.80 | |
| N,N-dimethylpropylamine | | |
| N,N-dimethylcyclohexylamine | | 0.80 |
| Water | 1.50 | 1.50 |
| blowing agent^{g} | 15.00 | 15.00 |

Component B

| | | |
|---|---|---|
| Polyisocyanate^{h} | 112.6 | 112.6 |
| Total | 112.60 | 112.60 |

TABLE 2

| | | |
|---|---|---|
| | | Comparative |
| Components | Example 2 | Example 2 |

Component A (100 parts)

| | | |
|---|---|---|
| Polyol 1^{a} | 30.00 | 30.00 |
| Polyol 2^{b} | 34.10 | 34.10 |
| Polyol 3^{c} | 9.50 | 9.50 |
| Flame retardant^{d} | 20.00 | 20.00 |
| Silicone oil 1^{e} | 1.00 | 1.00 |
| Silicone oil 2^{f} | 0.70 | 0.70 |
| 3-[2-(dimethylamino)ethoxy]- | 0.35 | |
| N,N-dimethylpropylamine | | |
| Bis-(2-Dimethyl-aminoethyl) | | 0.35 |
| ether (70% concentration) | | |
| Water | 1.50 | 1.50 |
| blowing agent^{g} | 15.00 | 15.00 |

Component B

| | | |
|---|---|---|
| Polyisocyanate⁹ | 112.6 | 112.6 |
| Total | 112.60 | 112.60 |

a: polyester polyol; PS2412 from the Stepan Company

b: polyether polyol; NJ8348 from the Stepan Company

c: polyether polyol: PEG600; from the Sinopharm Company

d: TCPP; from the Yake Company

e: L6100 from the Momentive Company

f: L6900 from the Momentive Company

g: HCFC-141b from the Solvay Company

h: Desmodur 44v20L from the Bayer Company (NCO% 32.5%)

For preparing the polyurethane foams, materials for Component A expect the blowing agent were first added to a container and stirred at 1000 rpm for 2 mins. Then, the blowing agent was added to the mixture and stirred at 500 rpm to complete Component A. Subsequently, Component A was added into a 500 ml paper cup, then Component B was added into the paper cup. The resulting mixture was stirred at 1500 rpm for 10 secs.

The Cream time, Gel time and Tack-free time were measured, respectively.

Cream time: time from foams leaving the dispensing equipment to beginning of volume expansion of the foams(seconds)

Gel time: time from foams leaving the dispensing equipment to the time point of thread formation on an inserted rod where the rod is repeatedly pulled in and out of the foams (seconds)

Tack-free time: time before dissipation of stickiness of the top surface (seconds)

After the foams were post cured, the free rise cup density (FRD(cup)) and free rise core density (FRD(core)) were measured. Free rise cup density means the density of foams which foams in an open container, e.g. a cup. Free rise core density means the density of the central core of the foams which have blown and free risen in the cup (without the surface and skin of the foam).

The odor strength of the foams was also evaluated by 5 panellists. The odor strength of the foams was rated as high, medium or low according to the perception of the panellists.

Results are shown in Tables 3 and 4 below:

TABLE 3

| | | Comparative |
|---|---|---|
| | Example 1 | Example 1 |
| Cream time (s) | 17.0 | 16.5 |
| Gel time (s) | 77.0 | 74.0 |
| Tack free time (s) | 155 | 145 |
| FRD (cup) | 42.5 kg/m³ | 38.4 kg/m³ |
| FRD (core) | 39.6 kg/m³ | 41.8 kg/m³ |
| Odor | Medium | Strong |

TABLE 4

| | | Comparative |
|---|---|---|
| | Example 2 | Example 2 |
| Cream time (s) | 32 | 16.5 |
| Gel time (s) | 162 | 147 |
| Tack free time (s) | >300 | 250 |
| FRD (cup) | 45.6 kg/m³ | 42.5 kg/m³ |
| FRD (core) | 42 kg/m³ | 38.4 kg/m³ |
| Odor | Medium | Strong |

The amine according to the present invention, compared to bis-(2-dimethyl-aminoethyl) ether, provided longer gel time and longer cream time, which represents a more moderate cure rate. On the other hand, the amine according to the present invention exhibited similar catalytic behaviours as N,N-dimethylcyclohexylamine, which is known to be a balanced catalyst and has high odor emission.

1-15. (canceled)

16. A process for preparing a polyurethane foam by reacting a polyisocyanate with a polyol in the presence of a blow agent and an amine, wherein the amine has the general formula of: 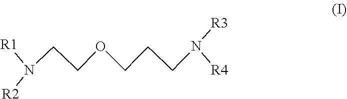
wherein R₁, R₂, R₃, R₄ are, independently, linear or branched a C₁ to C₄ alkyl, H, or —OH.

17. The process according to claim 16, wherein in general formula (I) at least one of R₁ and R₂ is methyl and at least one of R₃ and R₄ is methyl.

18. The process according to claim 16, wherein in general formula (I) R₁, R₂, R₃, R₄ are independently methyl, H, or —OH.

19. The process according to claim 16, wherein the amine is 3-[2-(dimethylamino)ethoxy]-N, N-dimethylpropylamine, 2-(3-(hydroxy(methyl)amino)propoxy) -N,N-dimethylethan-1-amine, 3-(2-(dimethylamino)ethoxy)-N-methylpropan-1-amine, or a mixture thereof.

20. The process according to claim 16, wherein a co-catalyst is present in the reaction mixture of the polyol and the polyisocyanate, wherein the co-catalyst is selected from the group consisting of tertiary amines, organometal compounds, metal carboxylates, and a mixture thereof.

21. The process according to claim 16, wherein a surfactant is present in the reaction mixture of the polyol and the polyisocyanate.

22. The process according to claim 21, wherein the surfactant is selected from the group consisting of alkoxysilane, polysilylphophonate, polydimethylsiloxane, siloxaneoxyalkylene block copolymer, and a mixture thereof.

23. The process according to claim 16, wherein the amount of the amine is in the range of from 0.01 to 10 parts by weight based on 100 parts by weight of the polyol.

24. A polyurethane foam comprising the reaction product of a polyisocyanate, a polyol, a blow agent and an amine, wherein the amine has the general formula of: 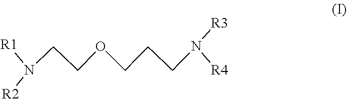
wherein R₁, R₂, R₃, R₄ are, independently, linear or branched C₁ to C₄ alkyl, H, or —OH.

25. The polyurethane foam according to claim 24, wherein in general formula (I) R₁, R₂, R₃, R₄ are independently methyl, H, or —OH.

26. A polyurethane foam comprising an amine having the general formula of: 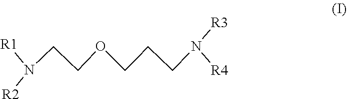
wherein R₁, R₂, R₃, R₄ are, independently, linear or branched C₁ to C₄ alkyl, H, or —OH.

27. The polyurethane foam according to claim 26, wherein in general formula (I) R₁, R₂, R₃, R₄ are independently methyl, H, or —OH.

28. The polyurethane foam according to claim 26, wherein the amine is 3-[2-(dimethylamino)ethoxy]-N,N-dimethylpropylam ine, 2-(3-(hydroxy(methyl)amino)propoxy) -N,N-dimethylethan-1-amine, 3-(2-(dimethylamino)ethoxy)-N-methylpropan-1-amine or a mixture thereof.

29. The polyurethane foam according to claim 26, wherein the polyurethane foam is a rigid polyurethane foam.

30. An article made with the polyurethane foam according to claim 26.
